(19) United States
(12) Patent Application Publication
(10) Pub. No.: US 2019/0344418 A1
(43) Pub. Date: Nov. 14, 2019

(54) Pneumatic Tool with Shock Absorber

(71) Applicant: Xinte Industrial Corporation Limited, Caotun Township (TW)

(72) Inventor: Ren-Zhi Liao, Caotun Township (TW)

(21) Appl. No.: 16/408,765

(22) Filed: May 10, 2019

(30) Foreign Application Priority Data
May 11, 2018 (TW) 107116168

(51) Int. Cl. B25D 17/24; B25D 17/11; B25D 17/04

(52) U.S. Cl. CPC B25D 17/245; B25D 17/11; B25D 2250/265; B25D 2217/0073; B25D 2250/181; B25D 17/04

(57) ABSTRACT

The present disclosure provides a pneumatic tool with shock absorber. The pneumatic tool has a main body which is adapted for an air supply to be connected thereto. With the air supply, a striker disposed in the main body reciprocates to generate impulse and vibration. A damper, including an elastic member and an airtight compartment, is disposed at the rear end of the reciprocation path of the striker. Therefore, the elastic member and the airtight compartment can absorb the shock produced backwardly by the striker. The vibration and the noise can be reduced for avoiding occupational injury caused thereby.

### RELATED APPLICATIONS

This application claims priority to Taiwan Application Serial Number 107116168, filed on May 11, 2018, which is herein incorporated by reference.

### FIELD OF THE INVENTION

The present disclosure relates to a pneumatic tool with shock absorber. More particular to a pneumatic impact tool which is provided with an internal spring and an airtight compartment, which are both for absorbing vibration caused by the reciprocation of the striker in the pneumatic impact tool to avoiding injury during operation.

### BACKGROUND OF THE INVENTION

Pneumatic impact tools are widely applied in architecture construction for crushing or boring. A pneumatic tool is usually assembled with a tool kit on the front end, suck as a striking pole. A striker in the pneumatic tool can reciprocate quickly in the tool to strike on the tool kit so as to generate impulse and vibration on the front end of the tool kit for crushing or boring.

Please refer to FIG. 1 to FIG. 3, the pneumatic tool has a main body 11, including a head portion 111 having a receiving space 112 and a handle 113 for being connected to an air supply (not shown). The handle 113 has a switch 114 for controlling the air provided into the receiving space 112 of the pneumatic tool. A valve assembly 12 is disposed in the receiving space 112. The valve assembly 12 includes a front member 121 which has a first bore 1211 and a rear member 122 which has a second bore 1221 and an air passage 123 communicating with the receiving space 112. The front member 121 and the rear member 122 are formed with a first channel 124 and a second channel 125 which are communicated to the air passage 123. A lamella 126 is disposed between the first bore 1211 and the second bore 1221. Two positioning poles 127 penetrate through first positioning holes 1212 on the front member 121 and second positioning holes 1222 on the rear member 122 for assembling the front member 121, the rear member 122 and the lamella 126. The lamella 126 can be moved to cover and seal the first bore 1211 or the second bore 1221. When the second bore 1221 is covered, as shown in FIG. 2, the air in the air passage 123 flows into the first bore 1211 via the first channel 124. When the first bore 1211 is covered, as shown in FIG. 3, the air in the air passage 123 flows into the second channel 125 via the second bore. A cylinder 13 is received in the receiving space 112 and is positioned in front of the valve assembly 12. The cylinder 13 has a striker 132 slidably disposed in a cavity 131 therein. The cylinder 13 has a connecting passage 133 on the lateral wall thereof. The connecting passage 133 communicates with the cavity 131 and the second channel 125. The cylinder 13 further has a dispersing hole 134 which communicates with the cavity 131 and the receiving space 112. The front end of the cylinder 13 is formed with an adapter 135 to which a connecting spring 136 is attached. The adapter 135 and the connecting spring 136 are provide for a striking pole 14 to be assembled thereon. The striking pole 14 has a front active end and rear passive end 141 which is inserted into the cavity 131.

Please refer to FIG. 1 and FIG. 2. The striker 132 may initially located at the rear end of the cavity 131. When the air is supplied to the air passage 123, since the pressure of the second bore 1221 is released to the environment via the second channel 125, the connecting passage 133, and the dispersing hole 134, the air presses the lamella 126 to move rearward to cover the second bore 1221. The air then flows into the cavity 131 via the first channel 124 and the first bore 1211 to push the striker 132 to quickly move forward and to hit on the rear passive end 141 of the striking pole 14.

Please refer to FIG. 3. After the striker 132 is moved forward, the pressure of the first bore 1211 is released to the environment via the cavity and the dispersing hole 134. The air supplied to the air passage 123 can presses the lamella 126 to move forward to cover the first bore 1211. The air then flows into the second bore 1221, the second channel 125, the connecting passage 133, and the cavity 134 to push the striker 132 to quickly move rearward to the initial position. Therefore, the striker 132 is reciprocated in the cavity 131 to repeatedly strike on the striking pole 14.

However, during the reciprocation, the striker 132 hits not only the striking pole 14 but the rear end of the receiving space on where the user is about to hold. The fierce striking of the striker induces severe vibration on the handle 113 which could cause occupational injury to the user. In addition, the striking also induces heavy noise which could causes hearing problems.

The present invention is, therefore, arisen to obviate or at least mitigate the above mentioned disadvantages.

### SUMMARY OF THE INVENTION

One of the objects of the present invention is to provide a pneumatic tool which produce less noise and less vibration on its handle.

To achieve the above and other objects, the present invention provides a pneumatic tool with shock absorber, comprising a main body, a valve assembly, a cylinder, and a damper. The main body has a head portion and a handle. The head portion is constructed with a receiving space. The handle having a switch disposed thereon. The switch is operated for allowing or stopping air from flowing into the receiving space. The valve assembly is disposed in the receiving space. The valve assembly has a first valve and a second valve, which are constructed with an air passage. The air passage communicates with the receiving space. The first valve has a first channel which communicates with the air passage. The first valve and the second valve are constructed with a second channel which communicates with the air passage. The valve assembly has a lamella which is disposed between the first valve and the second valve. The first valve is constructed with a compartment. The cylinder is disposed in the receiving space. The cylinder has a cavity and a striker. The cavity is located corresponding to the first channel. The striker is received in the cavity. The cylinder has a connecting channel communicating with the cavity and the second channel, leading reciprocation of the striker driven by the air flowed into the cavity via the first channel or the second channel. The damper comprises an elastic member and a pressing member which are disposed to the compartment. The reciprocating striker presses on and moving the pressing member to compress the elastic member and the air in the compartment.

In some embodiments, the first valve may be integrally formed in single piece or be constructed by a connecting member and a valve body.

In some embodiments, the first valve may be constructed by a tubular connecting member and a valve body provided with a protruding section, the valve body is assembled on a rear end of the connecting member.

In some embodiments, the first channel penetrates through the first valve. A first air passage is formed on an outer surface of the first valve. The first air passage communicates with the first channel and the receiving space. A second air passage is formed on the second valve. The second air passage communicates with the second channel and the receiving space.

In some embodiments, the compartment is defined between the connecting member and the protruding section of the valve body where the connecting member is sleeving around.

In some embodiments, the pressing member has a through hole communicating with the first channel and the cavity.

In some embodiments, the damper has a restricting structure for keeping the pressing member in position. In particular, the compartment has a diameter larger than a diameter of the cavity. The restricting structure includes an abutting surface formed on a rear end of the cylinder. The pressing member abuts against the abutting surface.

In some embodiments, the pressing member has a sealing member disposed on an outer surface thereof and an abutting member disposed on a front surface thereof.

In some embodiments, the cylinder is formed with a dispersing hole communicating with the cavity and the receiving space.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

The present disclosure can be more fully understood by reading the following detailed description of the embodiment, with reference made to the accompanying drawings as follows:

FIG. 1 is a break down drawing showing a conventional pneumatic tool;

FIG. 2 is a lateral section drawing showing a conventional pneumatic tool;

FIG. 3 is another lateral section drawing showing a conventional pneumatic tool;

FIG. 4 is a break down drawing showing a first embodiment of the present invention;

FIG. 5 is a top section drawing showing a first embodiment of the present invention;

FIG. 6 is a lateral section drawing showing a first embodiment of the present invention;

FIG. 7 to FIG. 9 are serial lateral section drawings illustrating consecutive motion of a first embodiment of the present invention;

FIG. 10 is a partial enlargement of FIG. 9;

FIG. 11 is a lateral section drawing showing the sequent condition of the first embodiment of the present invention of FIG. 9;

FIG. 12 is a partial enlargement of FIG. 11.

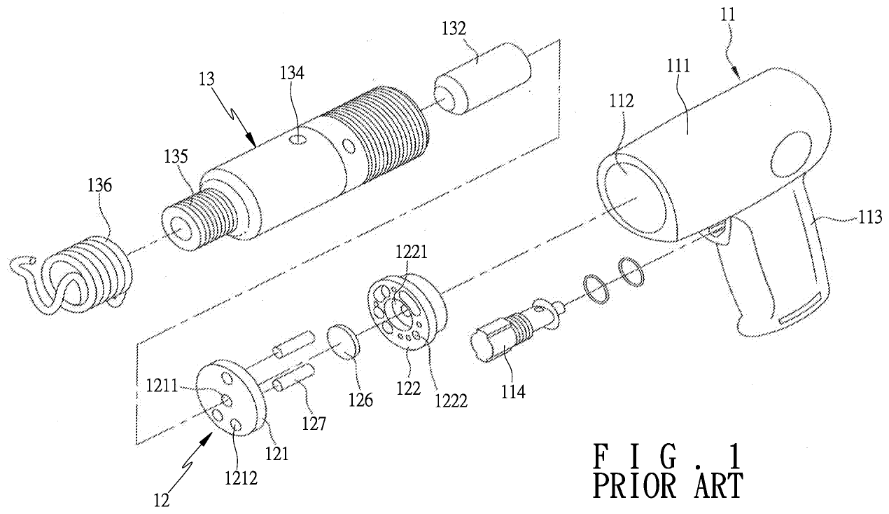

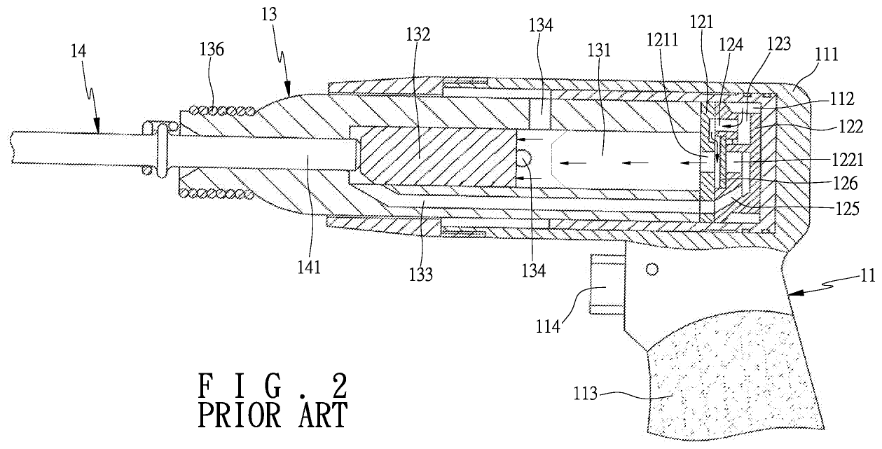

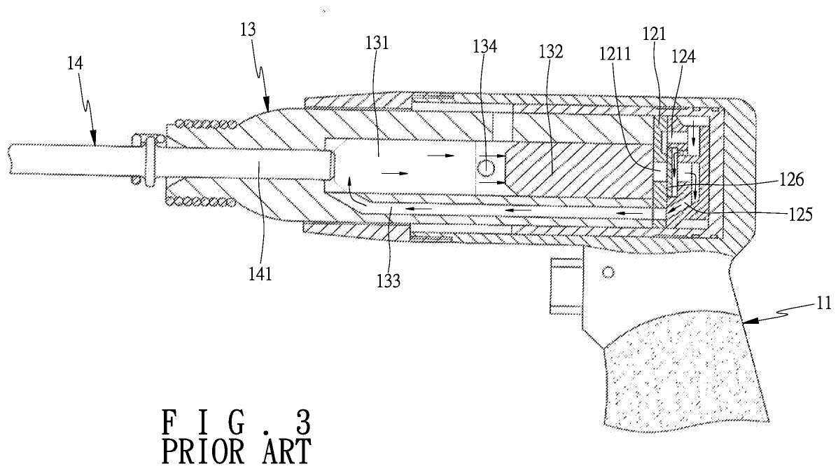

### DETAILED DESCRIPTION OF THE PREFERRED EMBODIMENTS

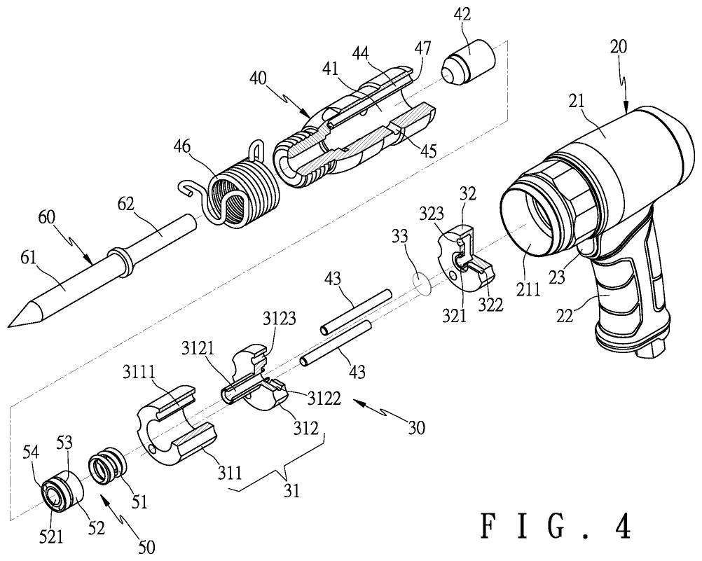

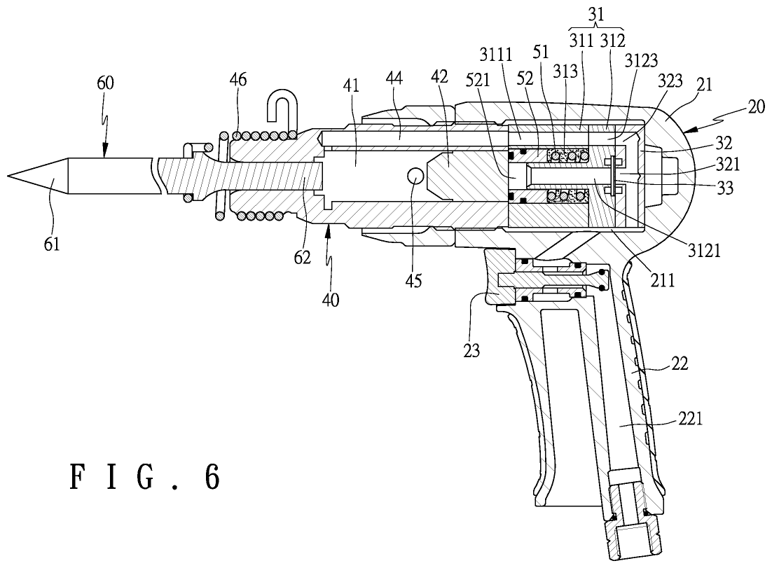

The present invention provides a pneumatic tool with shock absorber. Please refer to FIG. 4 to FIG. 6. The pneumatic tool of a first embodiment of the present invention includes a main body 20, a valve assembly 30, a cylinder 40, and a damper 50.

The main body 20 has head portion 21 and a handle 22. The head portion 21 is formed with a receiving space 211 therein. The handle 22 is integrally extended downwardly from the head portion 21, having an air inlet 221. One end of the air inlet 221 communicates with the receiving space, and the other end is adapted for an air supply (not shown) to be connected thereto. The handle 22 has a switch 23 disposed thereon for opening or closing the air inlet 221. When the switch 23 is pressed, the air can flow into the receiving space 211 via the air inlet 221. When the switch 23 is released, the air flow between the receiving space 211 and the air inlet 221 is then cut off.

The valve assembly 30 is disposed in the receiving space 211, having an air passage communicating with the receiving space 211. In the present embodiment, the valve assembly includes a first valve 31 and a second valve 32. The first valve may be integrally formed in a single piece, or, as shown in the present embodiment, is constructed by assembling a connecting member 311 and a valve body 312. The connecting member 311 is formed tubular, having a hollow portion therein. The valve body 312 is formed with a protruding section protruding axially forward. The valve body 312 is assembled on the rear end of the connecting member 311, and the protruding section is inserted and received in the hollow portion of the connecting member 311. The valve body 312 has a first channel 3121 which penetrates through the front end and the rear end of the valve body 312. The valve body 312 has a first air passage 3122 formed on an outer surface thereof. The first air passage 3122 communicates with the first channel 3121 and the receiving space 211. The air in the receiving space 211 can flow into the first channel 3121 via the first air passage 3122. The second valve 32 has an opening 321 on the front end thereof, and a second air passage 322 on an outer surface thereof. The second air passage 322 communicates with the opening 321 and the receiving space 211. The first valve 31 and the second valve 32 are constructed with a second channel, which includes a first section 323, a second section 3123, and a third section 3111. The first section 323 is formed on the front end of the second valve 32, communicates with second air passage 322. The second section 3123 is formed penetrating through the valve body 312, locating corresponding to the first section 323. The third section 3111 is formed penetrating through the connecting member 311. The air in the receiving space 211 can flow into the first section 323, the second section 3123, and the third section 3111 of the second channel via the second air passage 322. A lamella 33 is disposed between the first channel 3121 of the valve body 312 and the opening 321of the second valve 32 for selectively sealing the first channel 3121 or the opening 321. The first valve 31 is constructed with a compartment 313 which is defined between the connecting member 311 and the protruding section of the valve body 312.

The cylinder 40 is disposed in the receiving space 211 of the main body 20. The cylinder 40 has a cavity 41 in which a striker 42 is slidably disposed. One or several positioning poles 43 are disposed in the rear end of the cylinder 40, penetrating and assembling the first valve 31 and the second valve 32. The first channel 3121 communicates with the rear end of the cavity 41, so that the air flowing into the cavity 41 from the first channel 3121 can push the striker 42 to move forward. The cylinder 40 is formed with a connecting channel 44 in the side wall thereof. The connecting channel 44 communicates with the third section 3111 of the second channel and the cavity 41, so that the air can flow into the cavity 41 via the second air passage 322, the first section 323, the second section 3123, the third section 3111, and the connecting channel 44. The air flowing into the cavity 41 from the second air passage 322 (or the connecting channel 44) can push the striker 42 to move rearward. The cylinder 40 further has one or several dispersing holes 45 located at the middle portion of the cavity 41. The dispersing holes 45 respectively communicate with the cavity 41 and the receiving space 211. The striker 42 in the cavity 41 may located between the dispersing holes 45 and one of the first channel 3121 and the connecting channel 44. The air of the other one of the first channel 3121 and the connecting channel 44 is then released to the environment via the dispersing holes 45, leading pressure differentiation between the front end and the rear end of the striker 42. A restriction spring 46 is disposed to the frond end of the cylinder 40.

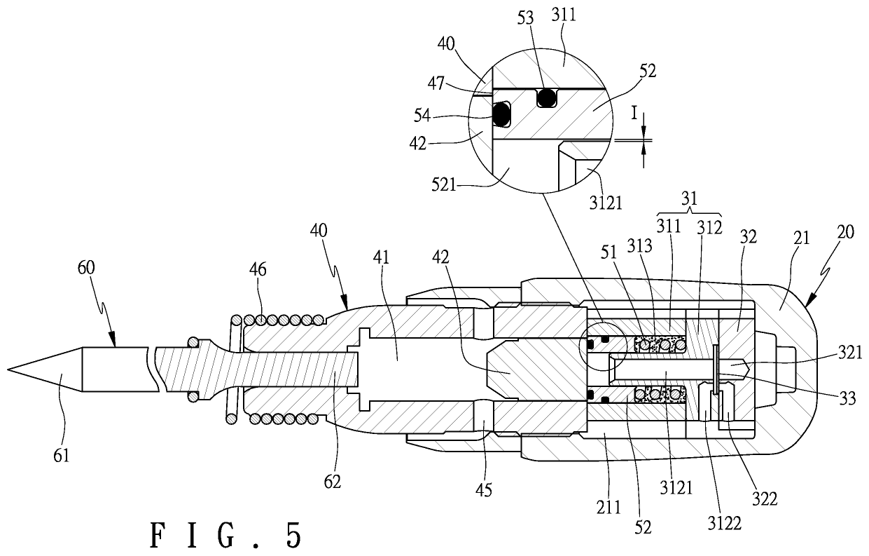

The damper 50 includes an elastic member 51, such as a spring, and a pressing member 52, such as a column piston. The elastic member 51 is received in the compartment 313. The pressing member 52 is slidably received at the front end of the compartment 313. The front end of the compartment 313 is obstructed by the pressing member 52, leading an airtight condition in the compartment 313. The pressing member 52 can be moved by striking and abutting of the striker 42. More particularly, the pressing member 52 is formed with a through hole 521 which communicates with the first channel 3121 and the cavity 41. It is noted that the compartment 313 may not be completely airtight. The air may still flow, but not too much, into or out from the compartment 313 via the through hole 521 and the thin interval I between the protruding section of the valve body 312 and the pressing member 52, as shown in FIG. 5. The damper 50 further includes a restricting structure for keeping the pressing member 52 in position. In the present embodiment, the diameter of the compartment 313 and the pressing member 52 is larger the that of the cavity 41, such that an abutting surface 47 on the rear end of the cylinder 40 is exposed to the pressing member 52. The pressing member 52 is abutted on the abutting surface 47 so as to keep the pressing member 52 in the compartment 313. The pressing member 52 has a sealing member 53, such as an o-ring, disposed on the outer surface thereof. The pressing member 52 further has an abutting member 54, such as another flexible o-ring, disposed on the front surface thereof. The abutting member 54 is provided as a cushion for the striker 42 to hit and to abut thereon.

A tool kit 60, such as a striking pole in the embodiment, is disposed at the front end of the cylinder 40. The tool kit 60 is trapped and held at the front end of the cylinder 40 by the restriction spring 46. The tool kit 60 has a front active end 61 extending forward and a rear passive end 62 inserting in to the cavity 41.

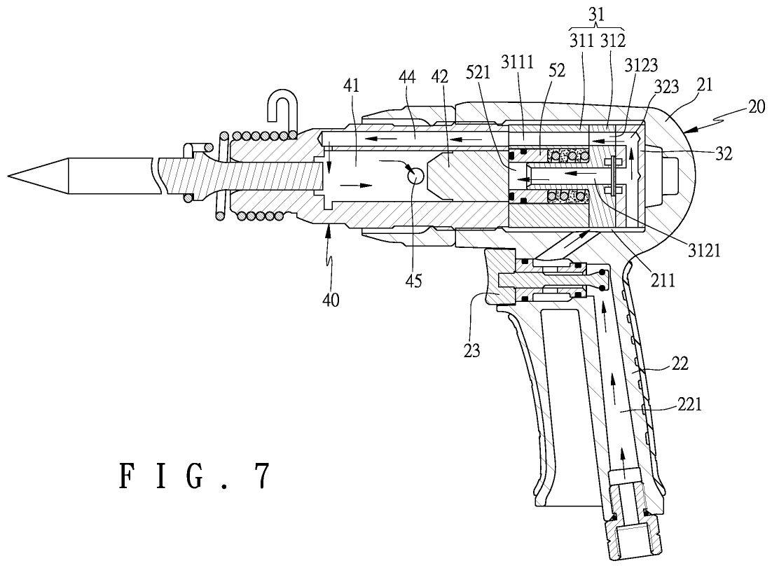

Please refer to FIG. 4 and FIG. 7. For operation, user may hold the pneumatic tool by the handle 22, pressing the switch 23 to activate the pneumatic tool. The inlet 221 is opened for the air to flow into the receiving space 211. The air further flows into the first air passage 3122 of the first valve 31 and the second air passage 322 of the second valve 32. The striker 42 may initially located at the rear end of the cavity 41. The front portion of the cavity 41 communicates with the dispersing holes 45. The air flowed into the second air passage 322 will disperse to the environment via the first section 323, the second section 3123, the third section 3111, the connecting channel 44, the cavity 41, the dispersing holes 45, and the receiving space 211. In the meantime, the through hole 521 of the pressing member 52 is covered by the striker 42. The air flowed into the first air passage 3122 is unable to be dispersed. Therefore, the air pressure of the front portion of the cavity 41 and the second air passage 322 is lower than the pressure of the first air passage 3122.

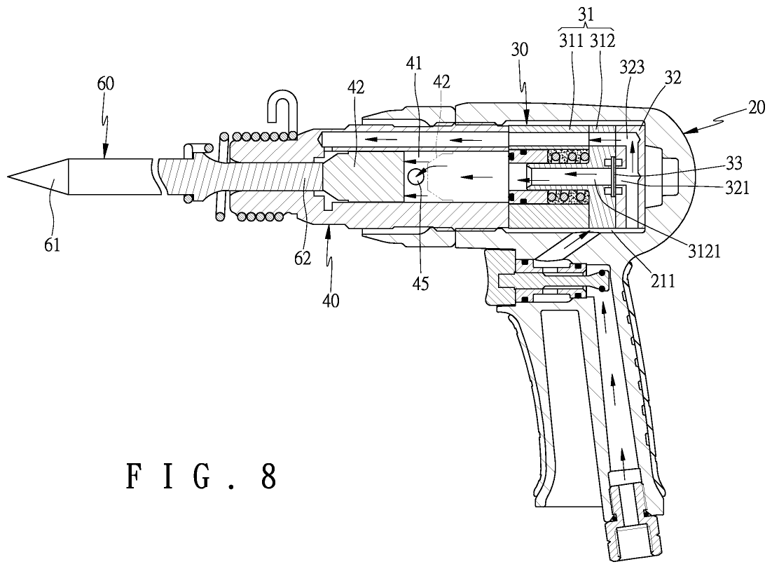

Please refer to FIG. 4 and FIG. 8. By the pressure difference between the first air passage 3122 and the second air passage 322, the air pushes the lamella 33 rearwardly to cover and to seal the opening 321 of the second valve 32. The air flowed into the first air passage 3122 is then flowing into the cavity 41 via the first channel 3121, pushing the striker 42 quickly moving forward to hit on the rear passive end 62 of the tool kit 60. Impulse is then generated and conducted to the front active end 61 of the tool kit for executing predetermined work, such as rock crushing.

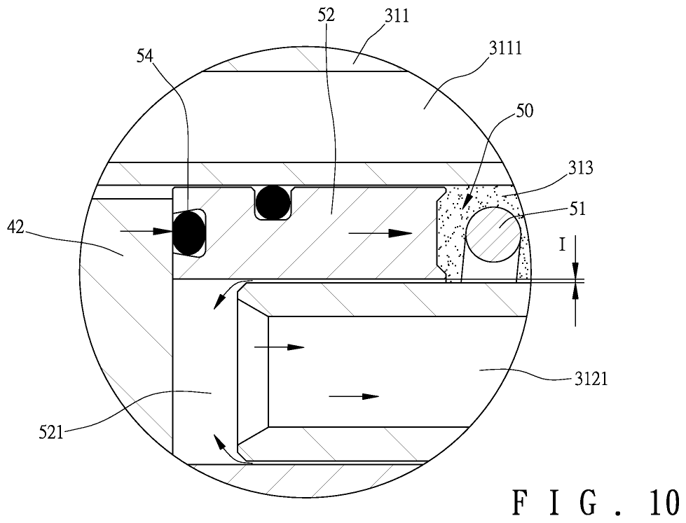

Please refer to FIG. 4 and FIG. 8 to FIG. 10. After the striker 42 hits on the rear passive end 62, the rear portion of the cavity 41 and the first channel 3121 are then communicating with the dispersing holes 45. The air flowed into the first air passage 3122, the first channel 3121, and the rear portion of the cavity 41 is dispersed via the dispersing holes 45 and the receiving space 211. On the other hand, the front end of the cavity 41 and the connecting channel 44 is obstructed by the striker 42 without air dispersing. The air pressure of the connecting channel 44, the third section 3111, the second section 3123, the first section 323, and the second air passage 322 is then risen to be larger than the pressure of the first channel 3121. By the air pressure difference, the air flows into the opening 321 and pushes the lamella 33 forward to cover the rear end of the first channel 3121. After that, the air flowed into the second air passage 322 flows into the cavity 41 and pushes the striker 42 quickly moving rearward to return to the initial position.

When the striker 42 is pushed to move rearward, the striker 42 hits on the pressing member 52. The abutting member 54 is firstly receiving and cushioning the hitting impulse from the striker 42. The pressing member 52 is then pushed and moved rearward to compress the elastic member 51, receiving and absorbing the impulse and the shock. In the meantime, the air in the compartment 313 is also compressed to act as a damping, also receiving and absorbing the impulse and the shock. The air in the compartment 313 can slightly flow in or out via the thin interval I between the valve body 312 and the pressing member 52, so as to smoothen the sliding motion of the pressing member 52.

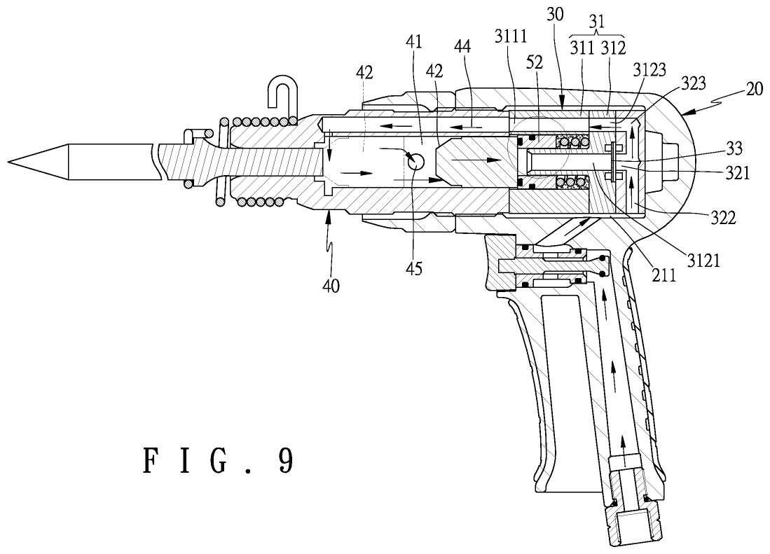

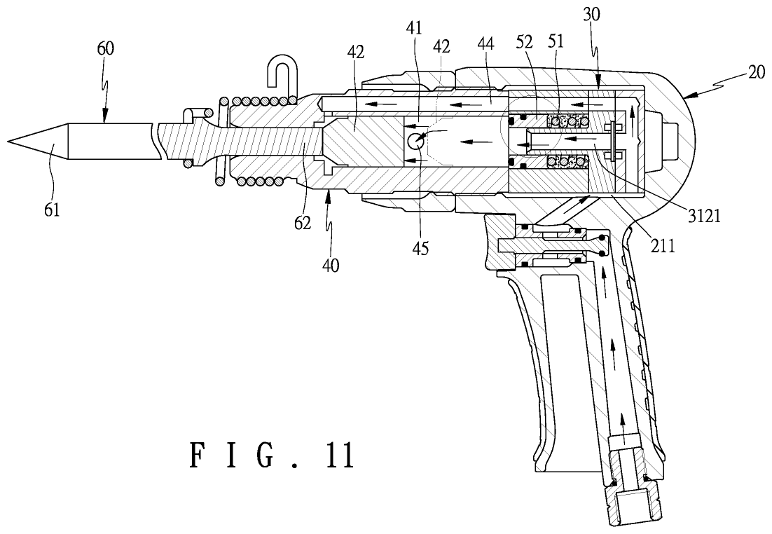

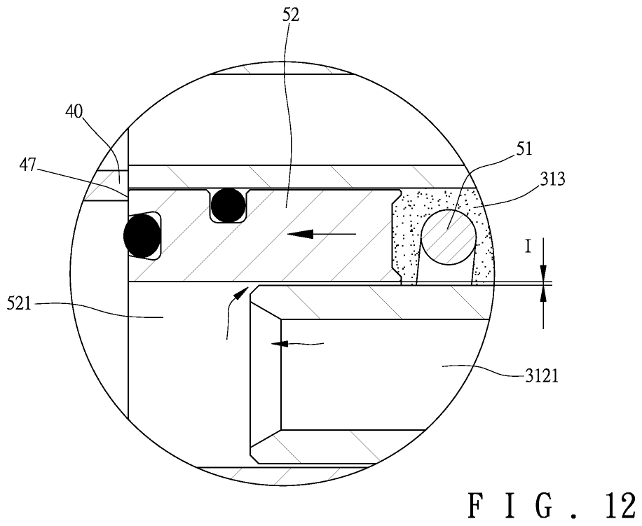

Please refer to FIG. 9, FIG. 11, and FIG. 12. Since the striker 42 is moved rearward to the initial position, the air pressure of the second air passage 322 is again lower than the pressure of the first air passage 3122. The air pushes the striker 42 to move forward again and reciprocating. When the striker 42 is moved forward again, the elastic member 51 which is compressed before can provide an elastic force through the pressing member 52 to the striker 42 to help and to enhance the forward movement of the striker 42. The pressing member 52 is restricted by the abutting surface 47, avoiding the pressing member 52 moving into the cavity 41. During the forward movement of the pressing member 52, the air in the compartment 313 can be replenished from the first channel 3121, the through hole 521, and the thin interval I between the valve body 312 and the pressing member 52.

According to the pneumatic tool mention above, both of the elastic member and the airtight compartment can absorb the shock and the vibration caused by the rearward movement of the striker. Thus, the shock and the vibration can be greatly reduced for preventing occupational injury. In addition, noise is also reduced by the elastic member and the airtight compartment. Operational condition is then improved.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A pneumatic tool with shock absorber, comprising:
a main body, having a head portion and a handle, the head portion being constructed with a receiving space, the handle having a switch disposed thereon, the switch being operated for allowing or stopping air from flowing into the receiving space;
a valve assembly, disposed in the receiving space, the valve assembly having a first valve and a second valve, which are constructed with an air passage, the air passage communicating with the receiving space, the first valve having a first channel which communicates with the air passage, the first valve and the second valve being constructed with a second channel which communicates with the air passage, the valve assembly having a lamella which is disposed between the first valve and the second valve, the first valve being constructed with a compartment;
a cylinder, disposed in the receiving space, the cylinder having a cavity and a striker, the cavity being located corresponding to the first channel, the striker being received in the cavity, the cylinder having a connecting channel communicating with the cavity and the second channel, leading reciprocation of the striker driven by the air flowed into the cavity via the first channel or the second channel;
a damper, comprising an elastic member and a pressing member which are disposed to the compartment, the reciprocating striker pressing on and moving the pressing member to compress the elastic member and the air in the compartment.

2. The pneumatic tool with shock absorber of claim 1, wherein the first valve is integrally formed in single piece or is constructed by a connecting member and a valve body.

3. The pneumatic tool with shock absorber of claim 1, wherein the first valve is constructed by a tubular connecting member and a valve body provided with a protruding section, the valve body is assembled on a rear end of the connecting member.

4. The pneumatic tool with shock absorber of claim 3, wherein the first channel penetrates through the first valve, a first air passage is formed on an outer surface of the first valve, the first air passage communicates with the first channel and the receiving space, a second air passage is formed on the second valve, the second air passage communicates with the second channel and the receiving space.

5. The pneumatic tool with shock absorber of claim 3, wherein the compartment is defined between the connecting member and the protruding section of the valve body where the connecting member is sleeving around.

6. The pneumatic tool with shock absorber of claim 1, wherein the pressing member has a through hole communicating with the first channel and the cavity.

7. The pneumatic tool with shock absorber of claim 1, wherein the damper has a restricting structure for keeping the pressing member in position.

8. The pneumatic tool with shock absorber of claim 7, wherein the compartment has a diameter larger than a diameter of the cavity, the restricting structure includes an abutting surface formed on a rear end of the cylinder, the pressing member abuts against the abutting surface.

9. The pneumatic tool with shock absorber of claim 1, wherein the pressing member has a sealing member disposed on an outer surface thereof, the pressing member has an abutting member disposed on a front surface thereof.

10. The pneumatic tool with shock absorber of claim 1, wherein the cylinder is formed with a dispersing hole communicating with the cavity and the receiving space.
